(19) United States
(12) Patent Application Publication
(10) Pub. No.: US 2012/0003372 A1
(43) Pub. Date: Jan. 5, 2012

(54) TWO-SIDED NONWOVEN ABSORBENT FOOD PAD

(75) Inventors: Sayandro VERSTEYLEN, Ontario, CA (US); Ronald JENSEN, Chicago, IL (US); Richard BEU, Yorba Linda, CA (US)

(73) Assignee: PAPER-PAK INDUSTRIES

(21) Appl. No.: 12/830,000

(22) Filed: Jul. 2, 2010

(51) Int. Cl. B65D 81/26; B32B 5/26; B65B 55/00

(52) U.S. Cl. 426/392; 206/204; 442/381; 442/382

(57) ABSTRACT

An absorbent food pad is disclosed having nonwoven top and bottom layers with an equal percentage surfactant by weight. The pad provides liquid strikethrough and absorbency without drying a food product, regardless of orientation of the pad when placed on a food tray.

### BACKGROUND OF THE DISCLOSURE

1. Field of Disclosure

The present disclosure relates to a two-sided nonwoven absorbent food pad having an equal proportion of surfactant added on each side to provide rapid strikethrough and absorbency, without drying a food product, regardless of the side having the food thereon.

2. Description of the Related Art

Conventional absorbent food pads are generally designed to be placed in a food tray with a certain side facing up (contacting the food product) and the opposite adjacent to the food tray, through which liquids exuded from the food product and any added liquids (such as marinades or added water) are absorbed. If the food-contacting side is constructed or treated so that liquids will readily penetrate to the absorbent material inside the absorbent food pad, the food product can rapidly dry out, thereby reducing consumer appeal as well as shelf life.

Consequently, absorbent food pads have been designed so that the top layer that contacts the food product is largely liquid-impermeable, and exuded liquids are largely taken up through the bottom layer that is closest to the food tray.

However, conventional absorbent food pads must be placed “right-side-up” in the food tray to operate as designed. In the event that an absorbent food pad is placed “upside down” in the food package, exuded liquids are absorbed directly through the food-contacting top layer of the absorbent food pad, resulting in rapid drying of the food product, and a reduction in shelf-life. The absorbed liquids may also pass back through the permeable top layer (effectively reversing the strikethrough) to wash over the food product, increasing the risk of contamination.

Conventional food pads can be designed to control the rate and total amount of liquid penetration through the top and bottom layers by one or more techniques that typically reduce or eliminate liquid penetration through the top (food-contacting) layer and increase liquid penetration through the bottom layer. One approach is to select different materials for the top and bottom layers, or to vary thickness and/or density of the materials. Another approach is to treat the bottom layer of the absorbent food pad with a larger amount of surfactant (wetting agent) that increases liquid permeability of the bottom layer as compared to the top layer. Still another approach to steer absorption primarily through the bottom layer is to mechanically perforate the material that forms the bottom layer to increase permeability to liquid exudates from food products.

Each of these approaches has the disadvantage that the absorbent food pad must be correctly placed in the food tray to operate as intended. Where absorbent food pads are placed in food trays by mass-assembly lines, a single human error in loading a feeder roll of absorbent food pads upside-down can require an entire line of food packages to be repackaged, with the wastage of the food packages and even the loss of the food product itself.

In addition, manufacture of an absorbent food pad having a different material (or different amounts of chemical treatments) for the top and bottom layers require extra handling and separate feeder lines, adding to manufacturing costs. Further, cost and time can be incurred to print “This Side Up” on conventional absorbent food pads to reduce the likelihood that the absorbent food pad will be incorrectly placed in the food tray.

### SUMMARY OF THE DISCLOSURE

There is provided an absorbent food pad having a top layer and a bottom layer made of nonwoven material treated with an equal percentage of surfactant by weight, based on the basis weight of the nonwoven, such that the absorbent food pad has identical liquid strikethrough and absorbency regardless of what layer contacts the food.

In addition, the basis weight of the nonwoven material and add-rate of the surfactant for top and bottom layers are scaled to provide excellent liquid strikethrough and absorbency, without drying the food product or compromising the non-slip properties of the absorbent food pad.

### BRIEF DESCRIPTION OF THE DRAWINGS

FIG. 1 is a perspective view of an exemplary embodiment of an absorbent food pad of the present disclosure, with a portion cut away to reveal the interior of the two-sided absorbent food pad.

FIG. 2 is a cross-section of an exemplary embodiment of the absorbent food pad in FIG. 1 taken along axis A-A to include an edge of the absorbent food pad.

FIG. 3 is a cross-section of another exemplary embodiment of the absorbent food pad in FIG. 1 taken along axis A-A to include a center portion of the absorbent food pad.

FIG. 4 is a perspective view of an exemplary embodiment of the absorbent food pad in FIG. 1 placed in a food tray with a food product.

FIG. 5A is a cross-section of an exemplary embodiment of the absorbent food pad in FIG. 4 taken along axis B-B, where the absorbent food pad is oriented in the food tray with the top layer in contact with the food product.

FIG. 5B is a cross-section of another exemplary embodiment of the absorbent food pad in FIG. 4 taken along axis B-B, where the absorbent food pad is oriented in the food tray with the bottom layer in contact with the food product.

FIG. 6 is a graph plotting the results of a test of Strikethrough Time for various exemplary embodiments of the present absorbent food pad having a nonwoven substrate treated with surfactant.

### DETAILED DESCRIPTION OF THE DISCLOSURE

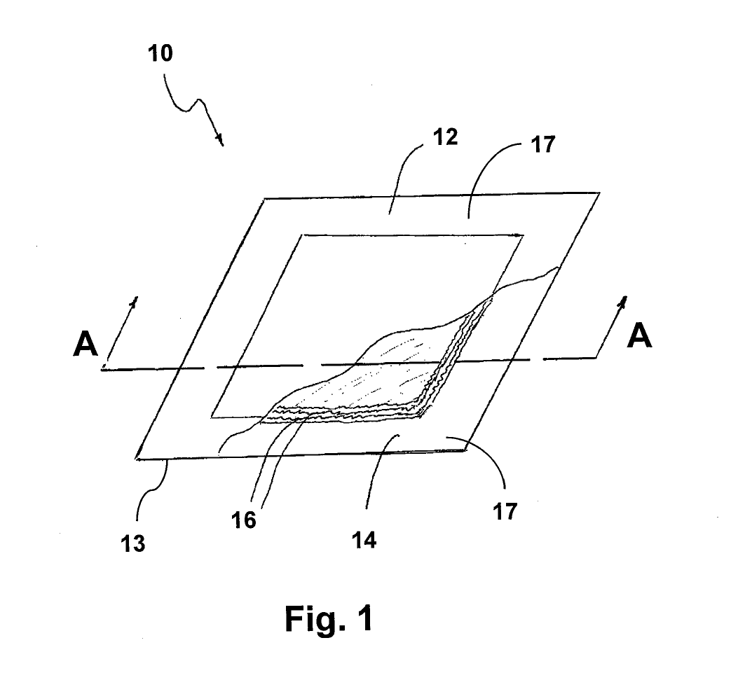

Referring to the drawings, and in particular, FIGS. 1 through 3, there is illustrated an exemplary embodiment of a two-sided nonwoven absorbent food pad of the present disclosure generally represented by reference numeral 10.

Referring to FIG. 1, absorbent food pad 10 has a top layer 12, and a bottom layer 14 opposite top layer 12. Between top layer 12 and bottom layer 14 are one or more absorbent layers 16, preferably tissue layers.

Top layer 12 and bottom layer 14 are made of a nonwoven. The nonwoven can be any nonwoven material, but is preferably a polyolefin, polyester, or polyamide. Examples of nonwovens for top layer 12 and/or bottom layer 14 include, but are not limited to, polypropylene, polyethylene, and/or polyester. In a preferred exemplary embodiment, top layer 12 is made of spunbond polypropylene, and bottom layer 14 is also made of spunbond polypropylene. As used in this application, “nonwoven,” “nonwoven material,” and “nonwoven substrate” for top layer 12 and bottom layer 14 have the same meaning. The nonwoven material preferably has a basis weight between about 15 GSM (Grams per Square Meter) to about 35 GSM. “Basis weight,” as used in this application, means the mass of a unit area of the nonwoven material, and is measured in Grams per Square Meter (GSM). Exemplary embodiments of the nonwoven for top layer 12 have a basis weight of about 30, 27, 25, 20, and 15 GSM, respectively. Exemplary embodiments of the nonwoven for bottom layer 14 also have a basis weight of about 30, 27, 25, 20, and 15 GSM, respectively.

Top layer 12 and bottom layer 14 are each made of a nonwoven material that is treated with a surfactant 17. Surfactant 17 is added to top layer 12 and to bottom layer 14 in proportion to the basis weight (in GSM) of each, so that top layer 12 and bottom layer 14 contain the same percentage of surfactant (% surfactant) by weight, based on the basis weight (thickness) of the nonwoven. For example, if top layer 12 and bottom layer 14 are each a nonwoven of 20 GSM, and the add-rate of surfactant 17 is 0.8%, then the amount of surfactant 17 added to top layer 12 is 0.12 grams and the amount added to bottom layer 14 is also 0.12 grams. If top layer 12 and bottom layer 14 are each a nonwoven of 30 GSM, and the add-rate is 0.8%, the amount of surfactant 17 added is 0.24 grams to each layer.

Surfactant 17 enhances strikethrough (permeability) of exuded liquids from the food product through top layer 12 and bottom layer 14 to contact absorbent layers 16, where the exuded liquid is absorbed and sequestered from the food product. Surfactant 17 can be an anionic, cationic, zwitterionic, non-ionic, or amphoteric surfactant, including, but not limited to, polyethylene glycol, polypropylene glycol, polysorbate, sulfosuccinate, SILASTOL® GF-16 (Schill & Seilacher, Boblingen, Germany), fatty amine oxide, linear alcohol ethoxylate, alkanolamide, alkylphenol ethoxylate, block co-polymer of ethylene oxide and propylene oxide, alkylphenol ethoxylate, alkylphenol polyethylene glycol ether, and any salts and/or any combinations thereof.

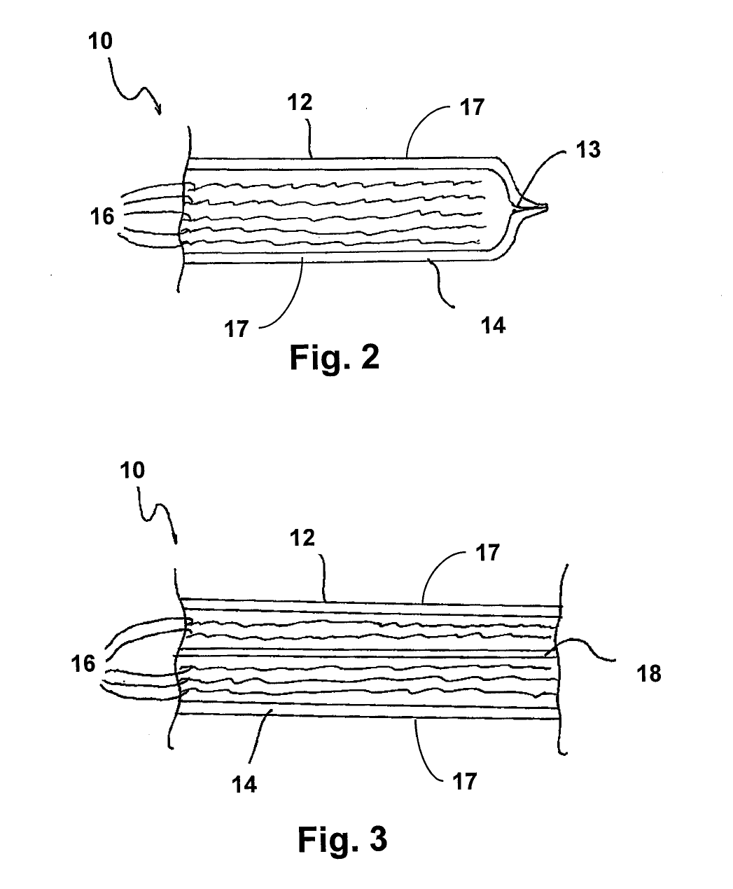

Referring to FIG. 2, in this exemplary embodiment, absorbent food pad 10 has top layer 12 and bottom layer 14 that are sealed at edge 13 to enclose five plies of absorbent layer 16, which is shown as natural tissue. Top layer 12 and bottom layer 14 are nonwovens that contain surfactant 17.

Referring to FIG. 3, in this exemplary embodiment, absorbent food pad 10 has a laminate layer 18 with absorbent material that is positioned between top layer 12 and bottom layer 14, and between absorbent tissue layers 16. Laminate 18 is one or more plies of a cellulosic material (two plies are shown), and can optionally include an active agent. In still another exemplary embodiment, laminate 18 is made of a mixture of cellulosic material and a CO₂-generation system (active agent) that is a mixture of citric acid and sodium bicarbonate, which, when activated with water or other liquid, react with each other to generate CO₂. Top layer 12 and bottom layer 14 are both nonwovens that are treated with surfactant 17.

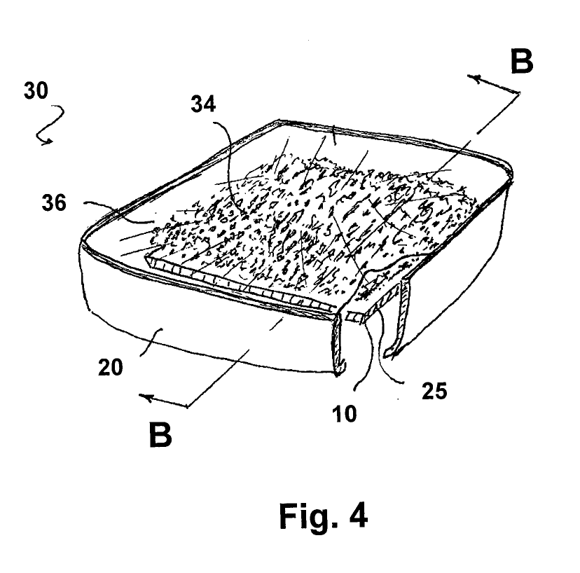

Referring now to FIG. 4, absorbent food pad 10 may be positioned in a food tray 20 so that either top layer 12 or bottom layer 14 faces upward toward the opening of food tray 20. Food product 34, such as ground sirloin, can be positioned on absorbent food pad 10. Lid film 36 can be stretched over food tray 20 to completely enclose absorbent food pad 10 and food product 34, thereby forming food package 30. An active agent 25 may be present in (or on) one or more absorbent layers 16 and/or laminate layer 18 in absorbent food pad 10.

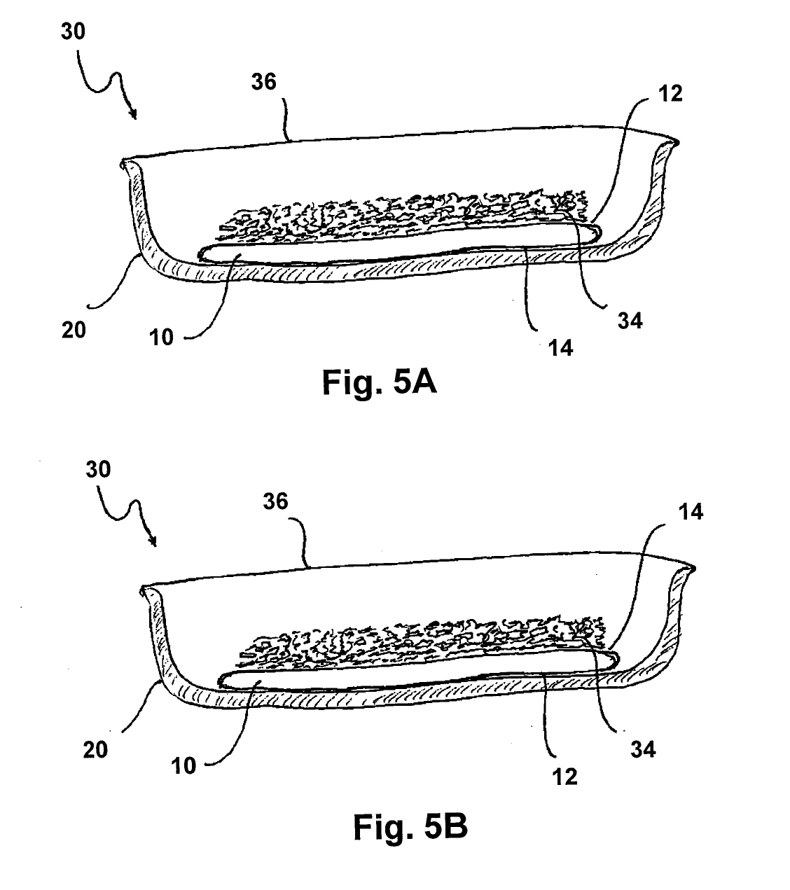

FIG. 5A and FIG. 5B illustrate that absorbent food pad 10 can be oriented in food tray 20 so that either top layer 12 or bottom layer 14 is facing upward to contact food product 34, and the opposite side is in contact with food tray 20. In the exemplary embodiment in FIG. 5A, top layer 12 contacts food product 34, and bottom layer 14 contacts food tray 20. In another exemplary embodiment in FIG. 5B, bottom layer 14 contacts food product 34 and top layer 12 contacts food tray 20. As shown below, basis weight of nonwoven and % surfactant for top and bottom layers are carefully balanced so that absorbent food pad 10 provides excellent strikethrough and absorption regardless of which side is placed in contact with food product 34, which is a benefit over conventional absorbent food pads.

Surfactant 17 is typically added to the nonwoven before assembly of top layer 12, bottom layer 14, absorbent layers 16 (and optionally laminate 18) to form absorbent food pad 10. However, absorbent food pad 10 may be assembled prior to treatment of the nonwoven layers with surfactant 17.

Nonwoven materials in top layer 12 and bottom layer 14 are inherently hydrophobic, and, prior to treatment with a surfactant, are substantially impermeable to liquid exuded from food products. Addition of surfactant 17 to the nonwoven increases permeability (and increases strikethrough) of top layer 12 and bottom layer 14 to liquids exuded from food product 34. Generally, the greater the amount of surfactant 17, and the thinner the nonwoven (as measured in GSM), the faster the speed of strikethrough.

The amount of exuded liquids that can be absorbed and retained by absorbent layers 16 and/or laminate 18 depends primarily on the nature of absorbent material and the number of absorbent layers. However, absorbency is also related to the nonwovens in top layer 12 and bottom layer 14, which provide a physical barrier that also helps retention of liquids absorbed in the absorbent layers. As used in this application, “retention” and “retention capability” mean how much of the exuded liquid that is absorbed is retained in the absorbent material in absorbent food pad 10. Thus, if an absorbent food pad has nonwovens in top layer 12 and/or bottom layer 14 that are too thin (i.e., have a low basis weight), or have too high a percent (%) surfactant, or a combination of these, the absorbent food pad can lose part or all of its retention capabilities.

In a preferred exemplary embodiment of absorbent food pad 10, neither top layer 12 nor bottom layer 14 have any perforations in the nonwoven. In another exemplary embodiment, top layer 12 and bottom layer 14 are each mechanically perforated to the same extent, such as when the same perforated nonwoven stock material is used for top layer 12 and bottom layer 14 to manufacture absorbent food pad 10.

The top and bottom surfaces of absorbent food pad 10 are inherently non-slip surfaces (i.e., having a high coefficient of friction). This is largely due to the fibers of the nonwoven used for top layer 12 and bottom layer 14. The non-slip characteristics of absorbent food pad 10 can reduce or prevent slippage of food product 34 that is positioned on top layer 12 or bottom layer 14, whichever layer is facing upward to contact food product 34. The non-slip characteristics also reduce or prevent slippage of absorbent food pad 10 in food tray. In a preferred embodiment, top layer 12 and bottom layer 14 are treated with a surfactant that does not substantially affect the non-slip properties of absorbent food pad 10.

Absorbent layers 16 are made of absorbent and/or superabsorbent material that absorbs moisture and liquids that exude from a food product placed on absorbent food pad 10. Each absorbent layer 16 itself can be formed of one or more cellulosic layers adjacent to each other or joined together to form the absorbent layer. Examples of absorbent material include, but are not limited to, natural tissue, fluff pulp, cellulosic material, binding fiber, airlaid, nonwoven, polymer, absorbent gel, thermoplastic polymer fiber, cellulose powder, or any combinations thereof. Examples of a superabsorbent material can include, but are not limited to, superabsorbent polymer (SAP), compressed SAP, composite of SAP granules adhered with binder or plasticizer, airlaid with SAP, and/or a starch-based superabsorbent material, such as BioSAP™ (Archer-Daniels Midland, Decatur, Ill.), which is biodegradable and compostable.

The number of absorbent layers 16, as well their arrangement in the pad architecture of absorbent food pad 10, can be varied to regulate the absorption for the absorbent food pad, as well as activation of any active agents therein. As used in this application, the “pad architecture” of an absorbent food pad means the structure and order of individual layers of absorbent layers 16, and any active agents therein. “Regulation,” as used in this application, means controlling the speed, location, and amount of liquid absorption, as well as controlling activation speed and duration of release of active agents. “Strikethrough,” as used in this application, means the penetration of liquid through top layer 12 and/or bottom layer 14. “Strikethrough time” means the time it takes for a given amount of liquid to penetrate through top layer 12 and/or bottom layer 14. “Strikethrough rate” means the speed at which a given amount of liquid penetrates through top layer 12 and/or bottom layer 14.

In an exemplary embodiment of absorbent food pad 10, top layer 12 and bottom layer 14 can form a pocket in which active agent 25 is held. A “pocket,” as used in this application, means an area between two layers in absorbent food pad 10 that can hold active agent 25 in position prior to activation. In another exemplary embodiment of absorbent food pad 10, a first absorbent layer 16 adjacent to top layer 12 and a second absorbent layer 16 adjacent to bottom layer 14 can form a pocket in which active agent 25 can be held. In still another exemplary embodiment, absorbent food pad 10 having a first absorbent layer 16 adjacent to top layer 12 can form a pocket between any of: top layer 12 and first absorbent layer 16; bottom layer 14 and first absorbent layer 16; and/or between top layer 12 and bottom layer 14. The active agent(s) 25 can be positioned in any pocket, and may be present in more than one pocket.

In a preferred exemplary embodiment, top layer 12 and bottom layer 14 are made of nonwoven material having the same basis weight, and treated with the same total amount of surfactant 17, thus forming a treated nonwoven top layer 12 and bottom layer 14 having an identical percentage add rate of surfactant 17 by weight. For example, top layer 12 and bottom layer 14 are each made of the same nonwoven material, such as spunbond polypropylene, that is 30 GSM, and treated with the same amount of surfactant 17, such as SILASTOL® GF-16, so that absorbent food pad 10 has the same % surfactant add rate for top and bottom layers.

In an alternative exemplary embodiment, top layer 12 and bottom layer 14 are made of nonwoven materials of different basis weight, but are treated with surfactant 17 is that same proportion to maintain the same percentage add rate for the surfactant by weight. For example, where top layer 12 is made of spunbond polypropylene that is 15 GSM, and bottom layer 14 is made of spunbond polypropylene that is 30 GSM, 0.12 g of surfactant 17 (0.8% by weight) is added to top layer 12, and 0.24 g of surfactant 17 is added to bottom layer 14 (0.8% by weight). In this way, the performance (i.e., strikethrough rate) is kept constant for top layer 12 as for bottom layer 14, no matter what basis weights of nonwoven are used.

The concentration of surfactant 17 relative to the basis weight of the nonwoven in top layer 12 and bottom layer 14 is critical to performance of absorbent food pad 10. A concentration of surfactant 17 that permits excellent strikethrough rates of liquid exuded from the food product with rapid acquisition of the exuded liquid into absorbent layer 16, and without drying the food product or compromising the retention capabilities of the absorbent layers 16 (i.e., loss of absorbency), is superior performance. By contrast, using a nonwoven having too low of a basis weight and/or treating the nonwoven with too large of an amount of surfactant 17 leads to drying of the food product and/or loss of retention capabilities of the absorbency of absorbent layers 16.

A concentration of surfactant 17 between about 0.30% to about 0.85% by weight, relative to the basis weight of the nonwoven material in top layer 12 and in bottom layer 14, provides excellent strikethrough and acquisition by absorbent layers 16, without drying the food product or compromising retention capabilities. Preferably, a concentration of surfactant 17 between about 0.57% to about 0.84% by weight, based on the basis weights of nonwovens for top layer 12 and bottom layer 14, provides superior performance for strikethrough, absorption and retention capability, without drying food product 34.

Pad architecture can be selected to regulate uptake of liquids exuded by a food product on absorbent food pad 10, as well as to regulate activation, rate of release, and duration of active agent 25. A pad architecture that physically separates the individual chemical components of active agent 25 can delay activation and/or provide an “extended release” of the active agent. For example, positioning a large number of absorbent layers 16 in absorbent food pad 10 can delay activation (and/or extend the duration of release) of active agent 25.

Active agent 25 includes, but is not limited to, one or more antimicrobial agent, one or more atmosphere modification system, or any combinations thereof. U.S. patent application Ser. No. 11/335,373, published as US Patent Application Publication No. US 2006/0172048, describes absorbent food pads having active agents, and is incorporated herein by reference. Antimicrobial agents may be selected from a bacterial inhibitor, fungal inhibitor, viral inhibitor, disinfectant, mildewstat, or any combinations. Examples of antimicrobial agent include, but are not limited to, a metal, metal compound, organic acid, inorganic acid, quaternary ammonium salt, sulfite, biopolymer, synthetic polymer, chitin, chitosan, nisin, enzymatic system, antioxidant, or any combinations. Examples of atmosphere modification systems can be a carbon dioxide generation system, oxygen scavenging system, ethylene blocking or scavenging system, or any combination. An exemplary embodiment of a carbon dioxide generation system in absorbent food pad 10 includes a system with an acid and base, where the acid may be citric acid or boric acid, and the base may be sodium bicarbonate, that, when reacted together, generate carbon dioxide. Oxygen scavenging systems in absorbent food pad 10 can include enzyme catalyzed oxidation reaction, metal oxidation reaction, or any combinations.

Scaling, i.e., selecting the proper amounts of active agent in relation to the amount of absorbent material and the type of food product being packaged, is critical to performance of absorbent food pad 10. Some food products, such as ground meats, exude very little liquid (also called “purge” in this application) that would be available to activate the active agent, while other foods (such as chicken, water-injected meats, sliced tomatoes, and cut celery) exude a large amount of moisture or liquid that must be acquired by the absorbent layers. For example, if absorbent food pad 10 has too many absorbent layers 16 relative to the amount of liquid purge, there may be insufficient liquid available to dissolve the active agent(s) to initiate activation. Conversely, if absorbent food pad 10 has too few absorbent layers 16, a large volume of exuded liquid can dilute or “drown” the active agent, thereby impairing its activation and/or effectiveness.

### EXPERIMENTAL

### Strikethrough Time for Nonwoven Substrates

Tests of strikethrough time for three (3) different absorbent food pads having different combinations of basis weight and % surfactant were tested to determine the relation of strikethrough time with the thickness of nonwoven (basis weight) and % surfactant. Ten (10) absorbent food pads were tested for each of the three combinations of basis weight and % surfactant. “Strikethrough time” was defined for this test as the time required for a fixed amount of distilled water to completely penetrate through the nonwoven substrates.

Each absorbent food pad was constructed with a nonwoven top layer, a nonwoven bottom layer, and eighteen (18) plies of natural tissue as the absorbent layers between the top layer and bottom layer.

Pad A had a top layer and bottom layer that were each 20 GSM nonwoven with 0.57° A) surfactant.

Pad B had a top layer and bottom layer that were each 20 GSM nonwoven with 0.84% surfactant.

Pad C had a top layer and bottom layer that were each 27 GSM nonwoven with 0.84% surfactant.

Test protocol: The absorbent food pad was placed on a flat surface. A stainless steel ring (2.75″ diameter and a 1.5″ wall) was placed on the center of the pad. Fifty (50) mL of distilled water were placed in the center of the stainless steel ring. A digital timer measured the time required for the water to be completely absorbed into the absorbent food pad. The test was repeated on ten separate pads for each Pad type. The average and standard deviation were calculated for each nonwoven/surfactant combination.

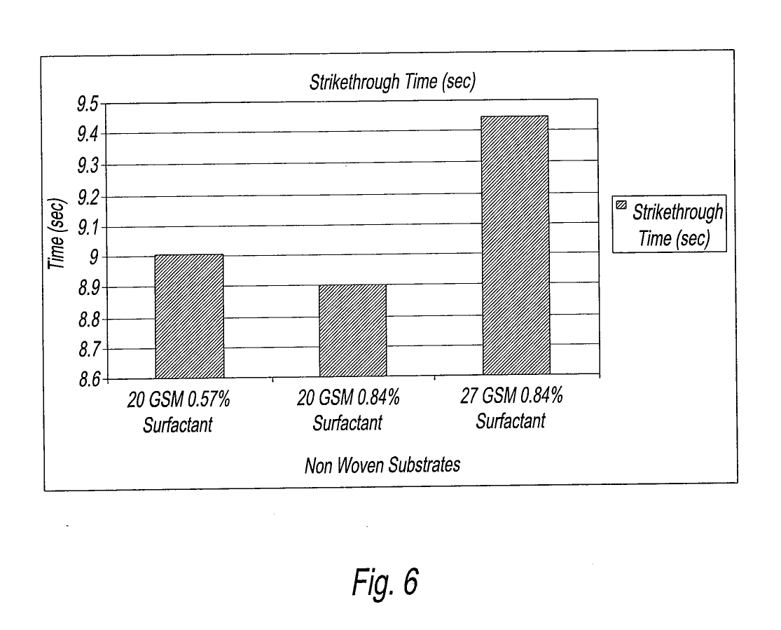

The results for the strikethrough time test are summarized in the graph in FIG. 6. The data for Pad A, Pad B, and Pad C are provided in Tables 1 to 3, respectively.

TABLE 1
Pad A
20 GSM nonwoven with 0.57% Surfactant

| Pad # | Pad Weight (g) | Strikethrough time (sec) |
|---|---|---|
| 1 | 17.7 | 9.15 |
| 2 | 17.6 | 9.61 |
| 3 | 17.7 | 9.37 |
| 4 | 17.6 | 9.46 |
| 5 | 17.5 | 9.84 |
| 6 | 17.6 | 8.42 |
| 7 | 17.3 | 7.99 |
| 8 | 17.3 | 8.52 |
| 9 | 17.4 | 8.66 |
| 10 | 17.1 | 8.95 |
| Average | 17.48 | 9.00 |
| Std Dev | 0.20 | 0.59 |

TABLE 2
Pad B
20 GSM nonwoven with 0.84% Surfactant

| Pad # | Pad Weight (g) | Strikethrough time (sec) |
|---|---|---|
| 1 | 17.3 | 8.96 |
| 2 | 17.2 | 8.61 |
| 3 | 17.0 | 9.76 |
| 4 | 17.8 | 8.84 |
| 5 | 17.7 | 9.05 |
| 6 | 17.7 | 8.73 |
| 7 | 17.7 | 8.88 |
| 8 | 17.7 | 8.75 |
| 9 | 17.4 | 8.92 |
| 10 | 17.6 | 8.60 |
| Average | 17.51 | 8.91 |
| Std Dev | 0.27 | 0.33 |

TABLE 3
Pad C
27 GSM nonwoven with 0.84% Surfactant

| Pad # | Pad Weight (g) | Strikethrough time (sec) |
|---|---|---|
| 1 | 17.7 | 10.17 |
| 2 | 17.7 | 9.92 |
| 3 | 17.9 | 9.03 |
| 4 | 18.0 | 9.49 |
| 5 | 17.9 | 9.46 |
| 6 | 17.6 | 9.06 |
| 7 | 18.1 | 9.65 |
| 8 | 18.1 | 9.35 |
| 9 | 18.2 | 8.89 |
| 10 | 17.9 | 9.94 |
| Average | 17.91 | 9.45 |
| Std Dev | 0.20 | 0.40 |

Based on the data above, absorbent food pads having the highest GSM grade (thickest) exhibited the longest strikethrough time. When comparing nonwovens of similar GSM grades, the nonwovens having the higher concentration of surfactant exhibited shorter (more rapid) strikethrough times.

The two-sided absorbent food pads disclosed herein can be used in food packages to extend shelf life and food freshness, and to enhance the appearance of packaged foods.

Unlike conventional absorbent food pads, absorbent food pad 10 may be placed either-side-up in a food package without compromising its operation in absorbing exuded liquids from the food product, and without drying out the food product.

Absorbent food pad can be a component of a case-ready food package. The case-ready food package includes: a food tray and absorbent food pad positioned on the food tray. The absorbent food pad includes a top layer that is a first nonwoven and a bottom layer opposite the top layer that is a second nonwoven. The first and second nonwovens have a surfactant present in equal percentage by weight, based on the basis weight of the top layer and the bottom layer, respectively. One or more absorbent layer is disposed between the top layer and the bottom layer. The top layer and bottom layer directly contact each other along their entire peripheries and enclose the one or more absorbent layer. A food product is positioned on the absorbent food pad. A lid, which can be a lid film, is placed over the food product and food tray, and is adhered to said food tray so that the food tray and lid completely enclose the absorbent food pad and food product.

Absorbent food pad 10 may be manufactured more efficiently than a conventional absorbent food pad. In an exemplary embodiment of a method for manufacturing absorbent food pad 10, the same source roll of treated nonwoven material is used for top layer 12 and for bottom layer 14.

The absorbent food pad of the present disclosure may be assembled by a method that includes contacting a top layer that is a first nonwoven with a bottom layer that is a second nonwoven, and enclosing an absorbent layer disposed between the top layer and the bottom layer. The first nonwoven and the second nonwoven contain an equal percentage of surfactant by weight, based on the basis weight of the first nonwoven and the second nonwoven. The method may further include an active agent disposed in the absorbent layer.

The absorbent food pad of the present disclosure may be used by a method that includes placing the absorbent food pad on a food tray with either the top layer or the bottom layer in contact with a food product, without drying the food product. The absorbent food pad includes a top layer that is a first nonwoven and a bottom layer opposite the top layer that is a second nonwoven. The first nonwoven and second nonwoven contain a surfactant in equal percentage by weight, based on the basis weight of the top layer and the bottom layer. An absorbent layer is disposed between the top layer and the bottom layer. The top layer and the bottom layer directly contact each other along their entire peripheries to enclose the absorbent layer.

The word “about,” as used herein for dimensions, weights, weight-percentages, or measures of absorbency, means a range that is ±10% of the stated value, more preferably ±5% of the stated value, and most preferably ±1% of the stated value, including all subranges therebetween.

As used herein, all references to the plural can also mean the singular and to the singular can also mean the plural, unless otherwise indicated.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

What is claimed is:

1. An absorbent food pad comprising:
a top layer comprising a first nonwoven;
a bottom layer opposite said top layer comprising a second nonwoven;
a surfactant present in said first nonwoven and said second nonwoven in equal percentage by weight, based on a basis weight of said first nonwoven and said second nonwoven; and
an absorbent layer disposed between said top layer and said bottom layer.

2. The absorbent food pad according to claim 1, further comprising an active agent present in said absorbent layer.

3. The absorbent food pad according to claim 2, wherein said active agent is an antimicrobial, atmosphere modification system, or combination thereof.

4. The absorbent food pad according to claim 1, wherein said first nonwoven and said second nonwoven each have said basis weight between about 15 grams per square meter (GSM) to about 35 GSM.

5. The absorbent food pad according to claim 1, wherein said first nonwoven and said second nonwoven are selected from the group consisting of polypropylene, polyethylene, polyester, and any combinations thereof.

6. The absorbent food pad according to claim 5, wherein said first nonwoven and said second nonwoven are spunbond polypropylene.

7. The absorbent food pad according to claim 1, wherein said surfactant is in said first nonwoven and in said second nonwoven in an amount between about 0.30% to about 0.85% by weight, based on said basis weight of said first nonwoven and said second nonwoven.

8. The absorbent food pad according to claim 7, wherein said surfactant is in said first nonwoven and said second nonwoven in said amount between about 0.57% to about 0.84% by weight, based on said basis weight of said first nonwoven and said second nonwoven.

9. The absorbent food pad according to claim 1, wherein said basis weight of said first nonwoven and said second nonwoven are 20 GSM, and said amount of said surfactant is 0.57% by weight, based on said basis weight of said first nonwoven and said second nonwoven.

10. The absorbent food pad according to claim 9, wherein said amount of said surfactant and said basis weight of said first nonwoven and said second nonwoven provide a strikethrough time that is less than about 9.5 seconds.

11. The absorbent food pad according to claim 10, wherein said amount of said surfactant and said basis weight of said first nonwoven and said second nonwoven provide a strikethrough time that is less than or equal to about 9.0 seconds.

12. The absorbent food pad according to claim 1, wherein said surfactant is selected from the group consisting of polyethylene glycol, polypropylene glycol, polysorbate, sulfosuccinate, fatty amine oxide, linear alcohol ethoxylate, alkanolamide, alkylphenol ethoxylate, block co-polymer of ethylene oxide and propylene oxide, alkylphenol ethoxylate, alkylphenol polyethylene glycol ether, and any salts, and any combinations thereof.

13. The absorbent food pad according to claim 1, wherein said first nonwoven and said second nonwoven have a different basis weight.

14. The absorbent food pad according to claim 1, wherein said top layer is a food-contacting layer.

15. The absorbent food pad according to claim 1, wherein said bottom layer is a food-contacting layer.

16. The absorbent food pad according to claim 1, further comprising a pocket formed between said top layer and said bottom layer.

17. The absorbent food pad according to claim 16, wherein said pocket holds an active agent prior to activation.

18. The absorbent food pad according to claim 1, wherein said top layer and said bottom layer directly contact each other along their entire peripheries, thereby enclosing said absorbent layer.

19. A case-ready food package comprising:
a food tray;
an absorbent food pad positioned on said food tray, comprising:
a top layer comprising a first nonwoven;
a bottom layer opposite said top layer comprising a second nonwoven;
a surfactant present in said first nonwoven and said second nonwoven in equal percentage by weight, based on said basis weight of said first nonwoven and said second nonwoven;
an absorbent layer disposed between said top layer and said bottom layer,
wherein said top layer and said bottom layer directly contact each other along their entire peripheries, thereby enclosing said absorbent layer; and
a food product positioned on said absorbent food pad; and
a lid placed over the food product and said food tray, and adhered to said food tray,
wherein said food tray and said lid completely enclose said absorbent food pad and the food product.

20. A method of using an absorbent food pad comprising:
placing said absorbent food pad on a food tray, wherein said absorbent food pad comprises:
a top layer comprising a first nonwoven;
a bottom layer opposite said top layer comprising a second nonwoven;
a surfactant present in said first nonwoven and said second nonwoven in equal percentage by weight, based on said basis weight of said first nonwoven and said second nonwoven; and
an absorbent layer disposed between said top layer and said bottom layer, and
wherein said absorbent food pad can be positioned in said food tray with either said top layer or said bottom layer in contact with a food product without drying said food product.
